(19) United States
(12) Patent Application Publication
(10) Pub. No.: US 2013/0154290 A1
(43) Pub. Date: Jun. 20, 2013

(54) Hook-Type Handling Device for Hoist with Indicator Arrangement

(71) Applicant: RUD Ketten Rieger & Dietz GmbH u. Co. KG, Aalen (DE)

(72) Inventors: Michael BETZLER, Abtsgmund (DE); Reinhard SMETZ, Nordlingen-Kleinerdlingen (DE)

(73) Assignee: RUD KETTEN RIEGER & DIETZ GMBH U. CO. KG, Aalen (DE)

(21) Appl. No.: 13/716,987

(22) Filed: Dec. 17, 2012

(30) Foreign Application Priority Data
Dec. 19, 2011 (DE) 10 2011 056 631.7

(51) Int. Cl. B66C 1/40

(52) U.S. Cl. CPC B66C 1/40
USPC 294/82.11

(57) ABSTRACT

The invention relates to a hook-type handling device (1) for a hoist, with an attachment opening (6) and two lateral suspension openings (8, 9) arranged symmetrically to it. In order to be able to make a simple check of whether or not the hook-type handling device (1) is inclined beyond a maximum permissible relative angle of inclination (W, W′) during use, according to the invention it is provided that the hook-type handling device (1) has an indicator arrangement (23) that indicates an inclined position (S) of the hook-type handling device (1) that goes beyond the maximum permissible relative angle of inclination (W, W′).

The invention relates to a hook-type handling device for a hoist (suspension tackle) with a maximum permissible relative angle of inclination and with a hook-type handling device body that has a central attachment opening and two lateral suspension openings arranged symmetrically to it.

Hook-type handling devices for hoists, for example, cable, belt or chain hoists, are known and are used, for example, for hoisting loads that often weigh several tonnes. In order to hoist particularly heavy loads, as a rule a hoist with a plurality of strands is used, for example, a four-strand hoist. Consequently, the load hangs, for example, on four chain strands that uniformly bear the load and that are intended to direct the load on to a central slinging mean. If, however, connecting points for the chain strands are imprecisely distributed on the load or if the individual chain strands have length tolerances, a non-uniform loading of the individual chain strands can result. Belts or cables can be used instead of chain strands. This can result in only two of the four chain strands directing the load to the slinging mean, which leads to an overload of the hoist and, in the extreme case, to at least one of the chain strands breaking. To compensate for such assembly or length tolerances, the hook-type handling device mentioned at the beginning is used.

The known hook-type handling devices can, however, compensate for the assembly or length tolerances to only a certain degree. In order to guarantee a favourable load distribution within the hook-type handling device, the hook-type handling device, when loaded, should not be inclined beyond the maximum relative angle of inclination. The maximum permissible relative angle of inclination is stipulated with reference to a direction of the load that acts on the slinging mean. If, due to the tolerances, the hook-type handling device is tipped beyond the maximum permissible relative angle of inclination with respect to the ideal attachment direction, it is no longer possible to guarantee safe hoisting of the load. The strands are loaded in a non-uniform manner.

The object of the invention is therefore to provide a hook-type handling device for a hoist with which a load can be safely hoisted.

This object is solved for the hook-type handling device mentioned at the beginning by means of an indicator arrangement that indicates, in a manner visible from outside the hook-type handling device, an inclined position of the hook-type handling device that goes beyond the maximum permissible relative angle of inclination.

On the basis of the indicator arrangement, an assembler assembling the hoist can quickly and reliably detect whether or not the inclined position or inclination of the hook-type handling device goes beyond the maximum permissible relative angle of inclination and can compensate for tolerances that arise during the assembly. Reliable hoisting of the load is guaranteed by means of this simple and quick check.

The solution according to the invention can be further improved by means of different developments, each advantageous in itself and all combinable in any way with one another. A discussion of these development forms and the advantages associated with them is given in the following.

In a first advantageous development form, the indicator arrangement can have at least one visually perceptible indicator element. For better recognizability, the indicator element differs from the hook-type handling device body, for example, by colour. Such an indicator element can indicate the inclined position of the hook-type handling device and it can possibly be read out without the use of further auxiliary materials. In order for the indicator element to represent the inclined position of the hook-type handling device at all times, it can move with the hook-type handling device body. For example, the indicator element can be connected to the hook-type handling device body in such a manner that it maintains a fixed position relative to the hook-type handling device body during movement, or it can be an integral part of the hook-type handling device body. In order to allow a quick and simple check of whether or not the hook-type handling device is situated or inclined beyond the maximum permissible relative angle of inclination, the indicator element can represent the maximum permissible relative angle of inclination.

According to a development form that is particularly advantageous because of its simple design, the indicator element can be formed as an indicator edge. The indicator edge can be developed in a straight manner so that it is easy to recognize the direction in which the indicator edge extends. In particular, the indicator edge can be aligned such that, when the maximum permissible relative angle of inclination is reached, it is arranged along a predetermined angle relative to the attachment direction, in which the attached load acts on the attachment opening or on the slinging mean. For example, the indicator edge can be aligned such that it is perpendicular or parallel to the attachment direction when the inclined position of the hook-type handling device reaches the maximum permissible relative angle of inclination. Such an alignment of the indicator edge is visually perceptible even without auxiliary materials, so that it is possible and simple to determine if the maximum permissible inclination of the hook-type handling device has been reached. In order to make it possible to recognize the indicator edge more quickly, it can be set off from the hook-type handling device body by having a different colour.

Due to the frequently harsh conditions and the large forces that act during the use of the hook-type handling device, there is a risk that the indicator element becomes damaged. In order to fashion the indicator element such that it is sufficiently robust for the use in mind, the indicator element can be formed by an outer edge of the hook-type handling device body. Even if the outer edge sustains somewhat minor damage caused by impacts, if the hook-type handling device is otherwise intact and ready for use, the outer edge nevertheless extends essentially along its original direction and can consequently reliably indicate the inclined position of the hook-type handling device.

Particularly an underside of the hook-type handling device body pointing away from the attachment opening can be formed with the indicator edge, because this is the most visible to the assembler during use. The indicator edge formed on the underside is, when the maximum permissible relative angle of inclination is reached, arranged at an angle that is simple to recognize visually, for example, vertical or horizontal to the ideal attachment direction.

If the indicator edge runs parallel to the attachment direction at an inclination state of the hook-type handling device that is barely still permissible, it indicates, in a more easily perceptible manner, however that the maximum permissible relative angle of inclination has been reached. Consequently, such an indicator edge can be provided in addition to or as an alternative to the outer edge. This indicator edge can be formed as one side of an indicator tongue and can run parallel to the attachment direction when the maximum permissible relative angle of inclination is reached. The side of the indicator tongue and possibly the entire indicator tongue can also be coloured in order to be set off visually from the rest of the hook-type handling device. In order to avoid damage to the indicator tongue, for example, as the result of bending, the indicator tongue can be embedded in the hook-type handling device body. For example, the indicator tongue can project into a central opening of the hook-type handling device body. In order to allow an indicator edge provided on the indicator tongue to move with the hook-type handling device body, the indicator tongue can be connected to the hook-type handling device body in such a manner that it maintains a fixed position relative to the hook-type handling device body during movement. For example, the indicator tongue can be attached to the hook-type handling device body or it can be formed as a single piece with the hook-type handling device body.

A comparison of the alignment of the indicator edge and the attachment direction by eye can be prone to error. In a further advantageous development form, the indicator arrangement of the hook-type handling device can consequently have a pointer that is movable relative to the indicator element and that indicates the inclined position of the hook-type handling device during operation. If the inclination of the hook-type handling device reaches the maximum permissible relative angle of inclination, the pointer can, for example, point to the indicator element. The indicator element is, for example, formed as the indicator edge of the indicator tongue. Alternatively, the indicator element can be formed as an indicator mark, for example, an arrowhead, a point, a dash or another visually perceptible structure.

The pointer can have an attachment segment by means of which the pointer can be connected to the hook-type handling device body. In a development form that is advantageous because it is simple to use, the pointer can be developed such that it can be connected to the hook-type handling device via its attachment segment and the slinging mean to attach the hook-type handling device. The pointer can be connectable to the hook-type handling device, particularly in such a manner that it cannot be detached, via the slinging mean. The slinging mean is, for example, a shackle with a retainer pin that can be inserted into the attachment opening. For connection to the slinging mean, the attachment segment of the pointer can have a hole whose inside diameter is greater than the outer diameter of the retainer pin.

The pointer can be connected to the slinging mean in such a manner that it swings freely, so that it points in the direction of the gravitational force in the manner of a plumb.

The freely swinging pointer only indicates the inclined position of the hook-type handling device correctly, however, if the attachment direction corresponds to the direction of the gravitational force. In addition, the pointer can be hindered in freely swinging by other factors. In order to ensure that the pointer indicates the inclination of the hook-type handling device body relative to the attachment direction, it can have an aligning device in which the slinging mean can be held in a predetermined assembly position. In order to ensure that the pointer is correctly aligned, it can be possible for the aligning device to hold the slinging mean particularly in only a single assembly position. In the assembly position, the pointer can point parallel to the ideal attachment direction and particularly opposite to the direction of the attachment force acting on the slinging mean.

In order for the pointer also to remain aligned parallel to the attachment direction if the hook-type handling device body is twisted, it can be possible for the pointer to be connected to the slinging mean by means of the alignment securing device in such a manner that it remains in a fixed relative position when turning. For example, the pointer can have two securing tabs, between which the slinging mean, for example, a leg of the shackle, can be mounted and held essentially in a form-fit, at least in sections.

The pointer can be formed as a stamped, forged, cast and/or lasered part whose securing tabs are bent after the stamping. For better recognizability of the pointer, it can be set off from the hook-type handling device body by colour. The hook-type handling device does not have to be formed as a stamped part. It can also be manufactured by means of master forming, for example, forging or casting, or by means of another separating process, for example, laser cutting. The hook-type handling device can also be forged, cast, stamped or lasered.

In a further advantageous development form, the display arrangement can have a spirit level affixed to the hook-type handling device body and having an indicator bubble and at least one tick mark. The spirit level can register and indicate inclined positions very precisely, whereby the indicator bubble, as the pointer, represents a current relative angle of inclination of the hook-type handling device, and the at least one tick mark, as the indicator element, represents the maximum permissible relative angle of inclination. As already described above, the indicator arrangement can also have a plurality of indicator elements, meaning tick marks, in this embodiment. The spirit level can be aligned perpendicular to an ideal alignment of the hook-type handling device with reference to the attachment direction, so that the indicator bubble is arranged centred between two tick marks if the hook-type handling device is loaded in a balanced manner.

In order to be able to pass on the largest loads possible, the hook-type handling device body can be formed with a framework structure. The framework structure allows the construction of an especially stable hook-type handling device, whereby the weight of the hook-type handling device body is not increased unnecessarily.

In particular, the framework structure can have a triangular framework section on whose corners the attachment and suspension openings can be arranged. The sides of the triangular framework section running between the suspension openings and the attachment opening are preferably formed as tension members and a side of the triangular framework section running between the suspension openings is preferably formed as a compression member. The compression member can be curved in the direction towards the attachment opening or in the direction away from the same in such a manner as to distribute uniformly the compressive forces caused by the load.

At least one of the suspension openings can be provided with an insertion opening in order to connect one of the chain strands to the hook-type handling device. The insertion opening can have an inner width that is smaller than the inside diameter of the suspension opening. For example, the suspension opening can be limited by a hook grab, whereby the load can be directed from the chain strand into the hook grab. The insertion opening can be flanked by a hook point of the hook grab and a limiting tab. The limiting tab can project from one side of the hook-type handling device body between the suspension opening and the attachment opening. In order to prevent the chain from catching on the limiting tab, a free end of the limiting tab can merge into a deflector tab that extends from the suspension opening to the nearest side of the hook-type handling device body.

The framework structure can enclose a central opening of the hook-type handling device body. In this way, the weight of the hook-type handling device body can be reduced without impairing its mechanical stability. The central opening can adjoin the attachment opening or it can be connected to the same by means of a junction canal. An inner width of the junction canal can allow elastic deformation of the compression member in the direction towards or in the direction away from the attachment opening. The indicator tongue can furthermore protrude into the central opening and it can be protected from damage by the sides of the framework section. The indicator tongue preferably has as its base the compression member and is arranged on the compression member in a centred manner.

The indicator arrangement has hitherto been described with only one indicator element. Because the hook-type handling device can, however, be inclined relative to the attachment direction in at least two directions, the hook-type handling device has a maximum permissible relative angle of inclination in each direction. The indicator arrangement can consequently have at least two indicator elements that limit a range of permissible relative angles of inclination. For example, the hook-type handling device can have two indicator edges or two indicator marks. The indicator arrangement can furthermore also be provided with more than two indicator elements that, e.g., form a scale and allow a more precise determination of the inclined position of the hook-type handling device.

According to an advantageous further development, secure attachment of the hoist with suspension elements to the hook-type handling device can be achieved if the suspension openings open outwards via a preferably slot-shaped insertion opening and the insertion opening has a smaller inner width than does the associated suspension opening. The insertion opening can extend particularly in a straight line from an outer edge of the hook-type handling device to the suspension opening. In this development of the suspension openings, a squeezed suspension element can be hung into the suspension opening in a manner that prevents loss. In order to be able to remove the hoist with suspension element quickly from the hook-type handling device during operation and, for example, use it without the hook-type handling device, the insertion and/or suspension opening can remain free of a closing element, i.e. open during operation.

In the following, the invention is explained by way of example on the basis of embodiments with reference to the drawings. The various characteristics of the embodiments can thereby be combined independently of one another, as was already explained above in the individual advantageous developments.

Shown are:

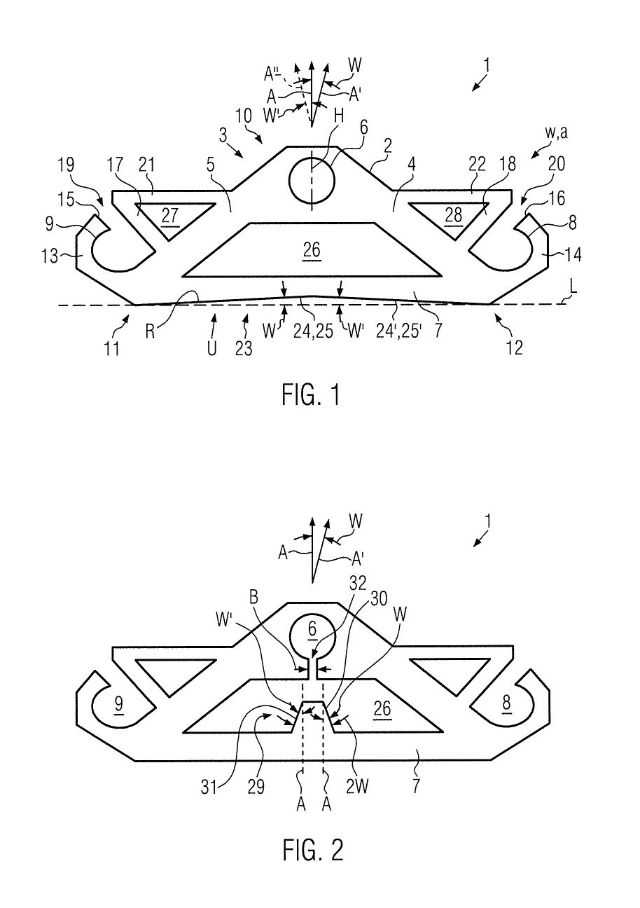

FIG. 1 a schematic depiction of a first embodiment of a hook-type handling device according to the invention;

FIG. 2 a schematic depiction of a second embodiment of the hook-type handling device according to the invention;

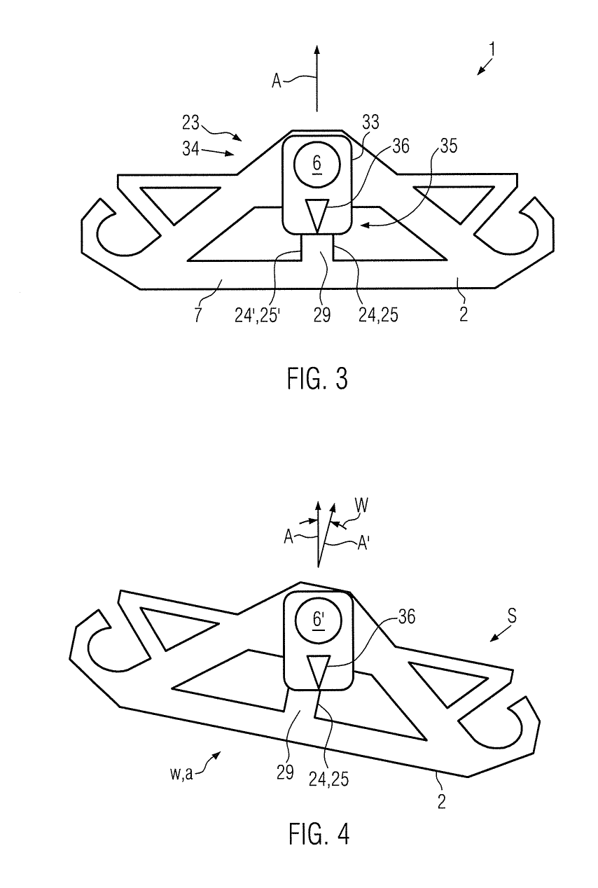

FIG. 3 a schematic depiction of a third embodiment of the hook-type handling device according to the invention;

FIG. 4 a schematic depiction of the embodiment of FIG. 3, whereby the hook-type handling device is positioned at a slant;

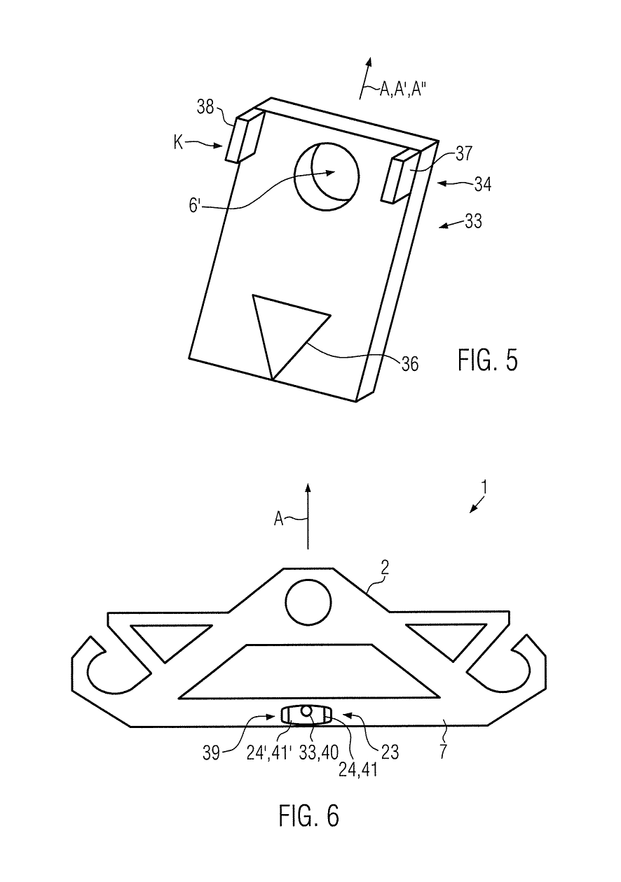

FIG. 5 a magnified view of an embodiment of a pointer of the hook-type handling device according to the invention;

FIG. 6 a schematic depiction of a fourth embodiment of the hook-type handling device according to the invention.

First the configuration and/or function of a hook-type handling device according to the invention is described with reference to the embodiment of FIG. 1.

FIG. 1 shows the hook-type handling device 1 schematically in a front view. The hook-type handling device 1 is formed with a hook-type handling device body 2 which can comprise a framework structure. The framework structure of the hook-type handling device body 2 can comprise a framework section 3 that can be formed essentially as a triangle and particularly as an isosceles triangle. Sides 4, 5 of the hook-type handling device body 2 enclose a tip of the equilateral triangle in which an attachment opening 6 is provided for the attachment of the hook-type handling device 1 to a slinging mean. The tip of the essentially triangular hook-type handling device body 2 is here shown, only by way of example, as flattened. A base 7 of the hook-type handling device body 2 that lies opposite the attachment opening 6 extends between suspension openings 8, 9 for connecting the hook-type handling device 1 to chain strands that lead to the load to be hoisted. The suspension openings 8, 9 can be provided particularly in the area of corners or base angles at which the sides 4, 5 meet the base 7.

The sides 4, 5 of the framework section 3 that is formed essentially triangularly can be formed as tension members and the base 7 can be formed as a compression member. In the area of the tip of the triangular framework 3, the sides 4, 5 can be connected to each other over a first nodal point 10 in a power transmitting manner. Each of the sides 4, 5 can be connected to the base 7 in a power transmitting manner over a second or third, respectively, nodal point 11, 12.

The suspension openings 8, 9 can be formed by suspension grabs or hook grabs 13, 14 that are open essentially in the direction towards the attachment opening 6 and that are attached to the second or third nodal point 11, 12. Each hook point 15, 16 can point toward a limiting tab 17, 18. Between the limiting tabs 17, 18 and the hook points 15, 16, a particularly slot-shaped insertion opening 19, 20 can extend for each suspension opening 8, 9, by means of which, for example, a suspension element (not shown) of a chain strand or of a belt or cable arrangement can be hung into the suspension opening 8, 9.

The suspension element can have a squeezed point at which its diameter is reduced and which can be slid through the insertion opening 19, 20. If the suspension element is then turned in the respective suspension opening 8, 9, the suspension element is hung into the hook-type handling device in such a manner that it cannot be lost as long as the non-squeezed material diameter is greater than the inner width of the insertion opening.

In order for it to be possible to remove the suspension elements and the hoisting strands attached to them quickly from the hook-type handling device, the insertion openings preferably remain open during operation. Advantageously, neither the insertion nor the inlet openings consequently have closing elements with which they can be closed.

In order to prevent the suspension element from hooking on the limiting tab 17, 18 and not in the hook grab 13, 14, a deflector tab 21, 22 can be provided. The deflector tab 21, 22 can extend from a free end of the limiting tab 17, 18 to the next nearest side 4, 5 of the hook-type handling device body 2.

At least the framework section 3 comprising the sides 4, 5 and the base 7 can be manufactured, and particularly burned, forged or cast, from one piece of metal. The hook grabs 13, 14 and/or the limiting tabs 17, 18 as well as the deflector tabs 21, 22 can, formed as a single piece with the framework section 3, form the hook-type handling device body 2. Alternatively to the depicted framework structure, the framework section 3 can also be formed as a plate that is provided with the attachment opening 6 and the suspension openings 8, 9 and that is otherwise continuous.

In use of the hook-type handling device 1 in accordance with the instructions, a chain strand is hung into each of the suspension openings 8, 9 and each transmits a weight load from an object that is to be hoisted to the hook-type handling device 1. The hook-type handling device 1 transfers the weight load to a slinging mean that extends at least partially through the attachment opening 6. The slinging mean is, for example, a shackle with a retainer pin, whereby during the use of the hook-type handling device 1, the retainer pin extends through the attachment opening 6 and the hook-type handling device 1 hangs on the retainer pin.

If the suspension openings 8, 9 are equally loaded, a retaining force that holds the hook-type handling device 1 and that is applied by the slinging mean extends in an ideal attachment direction A relative to the hook-type handling device body 2. The ideal attachment direction A is aligned, for example, essentially parallel to a bisecting line H that divides the angle between the sides 4, 5. If the suspension openings 8, 9 are loaded with different weights or in different directions, the hook-type handling device 1 can be tipped essentially around the attachment opening 6 by a current relative angle of inclination w so that a current attachment direction a is likewise tipped in comparison to the ideal attachment direction A. In the embodiment of FIG. 1, a barely still permissible attachment direction A′ is furthermore shown that is tipped a maximum permissible relative angle of inclination W with respect to the ideal attachment direction A. The maximum permissible relative angle of inclination W can be, for example, 10°. In the embodiment of FIG. 1, the attachment direction A′ is tipped clockwise with reference to the ideal attachment direction A by the maximum permissible relative angle of inclination W. Alternatively or additionally, the hook-type handling device 1 and consequently also the current attachment direction a can also be tipped counter-clockwise during operation up to a maximum permissible relative angle of inclination W′. In FIG. 1, however, the hook-type handling device 1 is shown ideally aligned.

In order to be able to recognize whether or not the hook-type handling device 1 is tipped by a permissible relative angle of inclination W, the hook-type handling device 1 can have an indicator arrangement 23. The indicator arrangement 23 can have at least one indicator element 24, which is perceptible visually and which represents the maximum permissible relative angle of inclination W. If the hook-type handling device 1 is permitted to be tipped in two directions until reaching the maximum permissible relative angle of inclination W, W′ during operation, the indicator arrangement 23 can also have a plurality and particularly two indicator elements 24, 24′.

According to the embodiment of FIG. 1, the hook-type handling device 1 is formed with two indicator elements 24, 24′. The indicator elements 24, 24′ can be formed by indicator edges 25, 25′, that, when the maximum permissible relative angle of inclination W, W′ is reached, extend along a stipulated direction. For example, one of the indicator edges 25, 25′ can be aligned parallel to a uniform load line L, whereby the uniform load line L runs perpendicular to the ideal attachment direction A.

If the load is distributed in a balanced manner on to the suspension openings 8, 9, the indicator edges 25, 25′ can be tipped counter-clockwise or clockwise relative to the uniform load line L by the maximum permissible relative angle of inclination W, W′ in the respective orientation. In this way, the base 7 can be formed such that it is convex or, as shown, concave on at least one side. The uniform load line L can, for example, be a horizontally aligned line if the ideal attachment direction A is aligned parallel to the gravitational force. In this case, the alignment of the indicator edge 25 to the uniform load line L can be checked in a purely visual manner or with the help of a spirit level.

Due to the framework structure, the hook-type handling device body 2 can have a central opening 26 enclosed by the sides 4, 5 and the base 7, whereby this central opening 26 is helpful for reducing the weight of the hook-type handling device 1. Each of the limiting tabs 17, 18 can also, with the deflector tabs 21, 22 and the sides 4, 5, enclose side openings 27, 28 and in this way further reduce the weight of the hook-type handling device 1.

The indicator edges 25, 25′ are preferably formed by an underside U of the hook-type handling device body 2 that faces away from the attachment opening 6. In particular, the indicator edges 25, 25′ can be formed by outer edges R of the underside U.

FIG. 2 shows the hook-type handling device 1 schematically in a further embodiment. The same reference numbers are used for elements that correspond in function and/or construction to the elements of the embodiment of FIG. 1. For the sake of brevity, only the differences to the embodiment of FIG. 1 are gone into.

In FIG. 2, the maximum permissible relative angle of inclination W is aligned clockwise with reference to the ideal attachment direction A. Alternatively or additionally, the maximum permissible relative angle of inclination W′ can be aligned such that it points counter-clockwise.

The compression member formed by the base 7 is not concave or convex as shown in FIG. 1 and is instead formed with a uniform thickness. If the bearing and distribution of loads allow a concave or convex forming of the compression member of the base 7 to appear advantageous, the compression member can also be formed concave or convex in this as well as in the embodiments still to come.

In order to indicate the inclined position of the hook-type handling device 1, an indicator tongue 29 can be provided. The indicator tongue 29 can have its base on the base 7 and can project into the central opening 26 in the direction towards the attachment opening 6. The indicator tongue 29 is thereby preferably arranged centred between the suspension openings 8, 9 and, in the ideal attachment direction A, in front of the attachment opening 6. In the ideal attachment direction A, the indicator tongue 29 can taper such that at least one side 30, 31 of the indicator tongue 29 runs at the maximum permissible relative angle of inclination W or W′ toward the ideal attachment direction A. If the maximum permissible relative angles of inclination W, W′ are equally large, the sides 30, 31 of the indicator tongue 29 can be aligned at an angle 2W with respect to each other, that can correspond to the sum of the amounts of the maximum permissible relative angles of inclination W, W′.

The attachment opening 6 and the central opening 26 can be connected to each other by means of a junction canal 32. Crosswise to the ideal attachment direction A, the junction canal 32 can have a width or an inner width B that is less than the diameter of the attachment opening 6.

FIGS. 3 and 4 show a further embodiment of the hook-type handling device 1, whereby the hook-type handling device body 2 of FIG. 4 is shown positioned askew in reference to the hook-type handling device 1 of FIG. 3 by a relative angle of inclination w that corresponds to the maximum permissible relative angle of inclination W. The same reference numbers are used for elements that correspond in function and/or construction to the elements of the previous figures. For the sake of brevity, only the differences to the embodiments of the previous figures are discussed.

FIGS. 3 and 4 show the indicator arrangement 23 of the hook-type handling device 1 with a pointer 33 and the indicator tongue 29. The pointer 33 has an attachment segment 34 by means of which the pointer 33 can be connected to the hook-type handling device body 2 such that it is movable relative to the indicator element 24, 24′. For example, the attachment segment 34 is formed with an attachment opening 6′, whose diameter corresponds to at least the diameter of the attachment opening 6 of the hook-type handling device body 2. If the hook-type handling device 1 is mounted on a slinging mean, the retainer pin, for example, can extend through the attachment openings 6, 6′ and connect the pointer 33 to the hook-type handling device body 2.

The pointer 33 can furthermore have an indicator section 35 which connects to the attachment segment 34 opposite to the ideal attachment direction A. The attachment opening 6′ can be arranged such that the majority of the mass of the pointer 33 is arranged in the indicator section 35. If the pointer 33 is connected to the hook-type handling device body 2 in such a manner that it swings freely, the pointer 33 can always point in the direction of the gravitational force in the manner of a plumb. If the ideal attachment direction A is not arranged parallel to the gravitational force or if the pointer 33 should always point parallel to the current attachment direction a, the pointer 33 can also be connectable to the slinging mean in a non-rotating manner.

The indictor section 35 can be provided with a tip that points opposite to the attachment direction A or an, for example, arrow-shaped indicator structure 36.

The indicator tongue 29 here is shown formed with indicator edges 25, 25′ that, in the embodiment of FIG. 3, are aligned parallel to each other and to the ideal attachment direction A. Because the pointer 33 now indicates the inclined position S of the hook-type handling device body 2, a comparison of the alignment of the indicator edges 25, 25′ and the stipulated direction is no longer necessary. Instead, the distance between the indicator edges 25, 25′ can now be selected such that the pointer 33 and particularly its indicator constructional structure 36 point to one of the indicator edges 25, 25′ if the inclined position S of the hook-type handling device 1 has reached the maximum permissible relative angle of inclination W, W′. The indicator edges 25, 25′ of the indicator tongue 29 do not have to run parallel to each other as is shown in FIG. 3 and can instead also be at an angle to each other. For example, the development of FIG. 2 can also be used with a pointer 33, so that when the maximum permissible relative angle of inclination W, W′ is reached, the pointer 33 is located on the indicator edges 25, 25′ and points in the direction of the indicator edges 25, 25′ or aligns with the indicator edges.

In a further embodiment that is, however, not shown here, the indicator section 35 of the pointer 33 can be longer than shown and in particular, can be formed such that it is so long that it extends at least close to the base 7 of the hook-type handling device body 2. In this case, it is possible to dispense with the indicator tongue 29, and the indicator elements 24, 24′ can, for example, be provided as indicator marks provided on the base 7. Indicator marks have, however, the disadvantage that they are no longer easily recognizable after a longer time of use of the hook-type handling device due to wear, dirt or damage to the surface.

In FIG. 4, the hook-type handling device body 2 is tipped clockwise by the maximum permissible relative angle of inclination W. The pointer 33 continues to be aligned parallel to the ideal attachment direction A. With this inclination of the hook-type handling device body 2, which is just barely still permissible, the indicator structure 36 points to the indicator element 24 or to the indicator edge 25 of the indicator tongue 29 that represents the indicator element 24. If the indicator tongue 29 is formed as shown in the embodiment of FIG. 2, the indicator edge 25 runs parallel to the current attachment direction a away from the tip of the indicator structure 36. In the shown embodiment, the indicator structure 36 points in particular to an end of the indicator edge 25. As soon as the indicator structure 36 points to an area outside of the indicator tongue 29, the hook-type handling device body 2 is inclined beyond the maximum permissible relative angle of inclination W.

FIG. 5 shows the pointer 33 of the embodiment of FIGS. 3 and 4 schematically in a magnified perspective depiction. The attachment segment 34 is shown with an alignment securing device K that has a securing tab 37, 38, as well as with the attachment opening 6′. The securing tabs 37, 38 can, for example, be bent side parts of the pointer 33 and can be arranged such that the slinging mean and particularly a side of the shackle can be arranged between the securing tabs 37, 38. The securing tabs 37, 38 give, on the one hand, an assembly position of the pointer 33 in reference to the assembly element. On the other hand, the securing tabs 37, 38 can be arranged such that the pointer 33 can be connected to the slinging mean in such a manner that it maintains a fixed position relative to the slinging mean during movement and in this way points in the current attachment direction a at all times. As a result, the indication of the inclined position S is independent of the gravitational force. The securing tabs 37, 38 are preferably formed as limiting or retaining tabs that can limit rotation of the pointer 33 in reference to the slinging mean or that can hold the pointer 33 on the slinging mean such that it cannot rotate with respect to the slinging mean.

FIG. 6 shows a further embodiment of the hook-type handling device 1 in a schematic side view. According to the depicted embodiment, the indicator arrangement 23 can have a spirit level 39 that can be attached to the base 7 and that can particularly be embedded in the same. The spirit level 39 can be provided on the hook-type handling device body 2 in such a manner that it is visible perpendicular to or in the ideal attachment direction A. The indicator arrangement 23 can have an indicator bubble 40 as the pointer 33. According to the shown embodiment, indicator elements 24, 24′ are developed as tick marks 41, 41′ of the spirit level 39. The tick marks 41, 41′ can thereby be arranged such that in the presence of the ideal attachment direction A, the indicator bubble 40 is arranged essentially centred between the tick marks 41, 41′ and when the maximum permissible relative angle of inclination W, W′ has been reached, the indicator bubble 40 is arranged on one of the tick marks 41, 41′. When the spirit level 39 is used, the inclined position S of the hook-type handling device body 2 can be determined very precisely. The current relative angle of inclination w can, however, only be compared to the direction of the gravitational force for the maximum permissible relative angle of inclination W, W′.

The hook-type handling devices described above can be used comparably for chain, cable or belt hoists.

1. Hook-type handling device (1) for a hoist, with a maximum permissible relative angle of inclination (W, W′) and with a hook-type handling device body (2) that has a central attachment opening (6) and two lateral suspension openings (8, 9) arranged symmetrically to it, characterised by an indicator arrangement (23) that indicates, such that it is visible from outside the hook-type handling device (1), an inclined position (S) of the hook-type handling device (1) that goes beyond the maximum permissible relative angle of inclination (W, W′).

2. Hook-type handling device (1) according to claim 1, characterised in that the indicator arrangement (23) has at least one visually perceptible indicator element (24, 24′) that moves with the hook-type handling device body (2) and that represents the maximum permissible relative angle of inclination (W, W′).

3. Hook-type handling device (1) according to claim 2, characterised in that the indicator element (24, 24′) is formed as an indicator edge (25, 25′) that is arranged along a predetermined angle relative to an ideal attachment direction (A) when the maximum permissible relative angle of inclination (W, W′) is reached.

4. Hook-type handling device (1) according to claim 3, characterised in that the indicator edge (25, 25′) is formed by an outer edge (R) of the hook-type handling device body (2).

5. Hook-type handling device (1) according to claim 3, characterised in that the indicator edge (25, 25′) is formed by a side (30, 31) of an indicator tongue (29) of the hook-type handling device (1).

6. Hook-type handling device (1) according to one of the claims 1 to 5, characterised in that the indicator arrangement (23) has a pointer (33) that is movable relative to the indicator element (24, 24′) and that indicates the inclined position (S) of the hook-type handling device (1) during operation.

7. Hook-type handling device (1) according to claim 6, characterised in that the pointer (33) has an attachment segment (34) that is developed such that it can be connected in a manner such that it cannot be detached to a slinging mean for attaching the hook-type handling device (1).

8. Hook-type handling device (1) according to claim 6 or 7, characterised in that the pointer (33) has an alignment securing device (K) in which a slinging mean for attaching the hook-type handling device (1) can be accommodated in a predetermined assembly position.

9. Hook-type handling device (1) according to claim 8, characterised in that the pointer (33) can be connected by means of the alignment securing device (K) to a slinging mean for attaching the hook-type handling device (1) such that it does not rotate with respect to the slinging mean.

10. Hook-type handling device (1) according to one of the claims 1 to 9, characterised in that the indicator arrangement (23) has, affixed to the hook-type handling device body (2), a spirit level (39) with an indicator bubble (40) and at least one tick mark (41, 41′), wherein the position of the indicator bubble (40) represents a current relative angle of inclination (w) and the tick mark (41, 41′) represents the maximum permissible relative angle of inclination (W, W′).

11. Hook-type handling device (1) according to one of the claims 1 to 10, characterised in that the hook-type handling device body (2) is developed with a framework structure.

12. Hook-type handling device (1) according to claim 11, characterised in that the framework structure has an essentially triangular framework section (3) on the corners of which the attachment opening (6) and suspension openings (8, 9) are arranged.

13. Hook-type handling device (1) according to claim 11 or 12, characterised in that the framework structure encloses a central opening (26) that is connected to the attachment opening (6).

14. Hook-type handling device (1) according to claim 11 or 12, characterised in that the indicator tongue (29) projects into a central opening (26) of the framework structure.

15. Hook-type handling device (1) according to one of the claims 1 to 14, characterised in that at least one of the suspension openings (8, 9) is provided with an insertion opening (19, 20) that runs along a limiting tab (17, 18), wherein the limiting tab (17, 18) projects from a side (4, 5) of the hook-type handling device body (2) running between the suspension openings (8, 9) and the attachment opening (6).

16. Hook-type handling device (1) according to one of the claims 1 to 15, characterised in that the suspension openings open outwards via an insertion opening (19, 20) and the insertion opening has an inner width that is less than that of the suspension opening (8, 9).

17. Hook-type handling device (1) according to one of the claims 1 to 16, characterised in that the insertion and/or suspension openings (19, 20; 8, 9) are free of closing elements.
